(19) United States
(12) Patent Application Publication
(10) Pub. No.: US 2016/0223496 A1
(43) Pub. Date: Aug. 4, 2016

(54) Method and Arrangement for Monitoring an Industrial Device

(71) Applicant: SIEMENS AKTIENGESELLSCHAFT, Muenchen (DE)

(72) Inventors: Hans-Henning KLOS, Feucht (DE); Dirk SCHEIBNER, Nuernberg (DE)

(21) Appl. No.: 15/021,547

(22) PCT Filed: Sep. 12, 2013
(86) PCT No.: PCT/EP2013/068873

§ 371 Date: Mar. 11, 2016

(51) Int. Cl. G01N 29/14

(52) U.S. Cl. CPC G01N 29/14

(57) ABSTRACT

A method and arrangement for monitoring an industrial device, such as a machine or a system, wherein the device comprises a rotating component and a bearing, wherein acoustic emissions of the device in a first frequency band in the ultrasound range are recorded, acoustic emissions of the device in a second frequency band in the ultrasound range are recorded, the first frequency band and the second frequency band being non-overlapping, where at least one characteristic value for the condition of the bearing is determined from the acoustic emissions of the device in the first frequency band, and where at least one characteristic value for a process variable of a process executing in the device is determined from the acoustic emissions of the device in the second frequency band such that monitoring of an industrial device is further improved while maintaining or reducing the complexity of the measurement.

### CROSS-REFERENCE TO RELATED APPLICATIONS

This is a U.S. national stage of application No. PCT/EP2013/068873 filed 12 Sep. 2013.

### BACKGROUND OF THE INVENTION

1. Field of the Invention

The invention relates to a method and an arrangement for monitoring an industrial device such as a machine or a system.

2. Description of the Related Art

Industrial equipment, such as machines or systems, generally incorporate various items of instrumentation for measuring variables for different purposes. On the one hand, typical process variables describing the actual process, such as pressures or temperatures, are measured. For example, the flow of lubricant in a lubricant circuit is a process variable which is measured and monitored for open- and/or closed-loop control of the lubricant circuit or the overall industrial device.

On the other hand, the wear and tear of such devices is monitored by a condition monitoring system with the aim of providing condition-based maintenance. Bearing friction, for example, is determined for condition monitoring.

In particular, the friction in bearings (rolling-element and plain bearings) and the flow of lubricant (e.g., oil) are essential for the reliable operation of machines and systems according to design specifications. It is therefore advisable and advantageous to monitor both events using appropriate instrumentation.

According to the prior art, separate sensors are used for the individual monitoring operations, particularly if they are relevant for different domains such as condition monitoring and process monitoring. For example, an oil circuit is monitored by measuring the power consumption of the pumps or via flow or pressure sensors. Friction in bearings is monitored by separate temperature sensors.

The oil circuit and associated instrumentation is often designed separately and not linked in any way, or only slightly, with the condition monitoring system of the bearing diagnostics (as different manufacturers are usually involved). However, the operation of the oil circuit directly affects the operating characteristics of oil-lubricated bearings and gear mechanisms. In particular, the flow rate, viscosity, temperature, pressure, abrasive wear and foreign particles in the oil circuit are important influencing variables that jointly determine the useful life of the bearings and gear mechanisms.

However, the problem is that bearing friction is detected only after a significant delay and with a degree of smoothing using temperature sensors. Brief friction events due to particles in the bearing cannot be detected directly. A significant temperature increase often only occurs shortly before total failure of the bearing.

To improve condition monitoring, it is already known to detect acoustic emissions in the ultrasonic range and determine therefrom characteristic values for the condition of a bearing (see, e.g., EP 2 623 949 A1, WO 2009/037077 A2, WO 2013/044973 A1 and the as yet unpublished patent application PCT/EP2012/057177). Sensors for measuring acoustic emissions in the ultrasonic range, frequently also termed “acoustic emission sensors”, provide information about ultrasonic acoustic waves propagating in solid bodies. The acoustic emissions in question occur during a wide range of events, such as friction, electric discharge, leakage or corrosion. Material-specific frequencies excited during irreversible plastic deformation are measured. The characteristic values determined therefore relate to “irreversible” material changes or shape modifications (e.g., fractures, cracks, erosion, or deformation) of the bearing itself, i.e., of a component of the industrial device. In contrast to this, a process variable is a variable which (co-) characterizes a process executing in the device, such as a manufacturing process or machining process for a product. This is generally a “reversible” variable whose value can change depending on the operating condition, but may also repeatedly assume previous values (e.g., in the event of identical operating conditions).

Specifically from WO 2009/037077 A2, it is already known to measure a device's acoustic emissions in the ultrasonic range in different, non-overlapping frequency bands during operation of the device. From the acoustic emissions of the device in a first higher frequency band, at least one characteristic value for bearing damage currently occurring is determined and, from the acoustic emissions of the device in a second lower frequency band, at least one characteristic value for bearing damage that has already occurred is determined.

### SUMMARY OF THE INVENTION

In view of the foregoing, it is an object of the present invention to provide a method and an arrangement whereby, with the same or even reduced instrumentation complexity, the monitoring of an industrial device, such as a machine or a system, can be improved still further.

This and other objects and advantages are achieved in accordance with the invention by providing an arrangement and method for monitoring an industrial device, such a machine or a system, where the device has a rotating component and a bearing for the component, during operation of the device, acoustic emissions of the device are measured in a first frequency band in the ultrasonic range and in a second frequency band in the ultrasonic range, and where the first frequency band and the second frequency band do not overlap. From the acoustic emissions of the device in the first frequency band, at least one characteristic value for the condition of the bearing is determined and, from the acoustic emissions of the device in the second frequency band, at least one characteristic value for a process variable of a process running in the device is determined.

The invention is based on the concept of monitoring a process variable on the basis of its acoustic emissions in addition to using acoustic emissions to monitor the condition of the bearing. As has been shown in practice, many process variables produce acoustic emissions in the ultrasonic range in frequency bands that are different from the frequency bands used for condition monitoring. This occurs in a frequency range in which conventional acoustic sensors operating in the ultrasonic range are still sensitive enough for condition monitoring. For example, in the case of an oil circuit, a wideband “noise-shaped” excitation caused by the oil circulation occurs in the frequency range between 30 and 80 kHz. This excitation is produced by the friction in the oil itself and the friction of the oil directly against the boundary surfaces, and propagates in the housing of the machine. These vibrations are typically also measurable directly on the bearing and can therefore be detected by a bearing-mounted sensor.

An operating condition of the sub-process assigned to the process variable, for example, can be inferred from the characteristic value for the process variable. By determining the process variable, monitoring of the industrial device can therefore be improved, thereby increasing the operational reliability of the industrial device.

It is therefore possible, using the sensor and evaluation technology already being employed for condition monitoring, to perform both monitoring tasks, preferably using the same sensor, thereby enabling the instrumentation complexity to be reduced. The frequency ranges can be separated out from a vibration signal by analog and/or digital filters. Alternatively, however, it should be understood that separate sensors can also be used for the two frequency bands, where one of the sensors has its resonant frequency in the region of the first frequency band and the other sensor has its resonant frequency in the region of the second frequency band, and where both sensors are, for example, co-located in a single sensor device such as a sensor head. The acoustic emissions in the two frequency bands are preferably measured simultaneously, thereby enabling particularly accurate monitoring to be achieved. However, subject to reduced accuracy, it is basically also possible to measure the acoustic emissions consecutively, e.g., at regular intervals, alternately in just one of the frequency bands in each case.

The at least one characteristic value for the process variable can be, for example, an envelope of a sensor signal, a root-mean-square value or a maximum value. The characteristic value can also be determined by further frequency analysis based on the variation over time of the sensor signal and the envelope thereof. For example, unwanted signals caused by known bearing frequencies or fixed-frequency electrical parasitics can be filtered out in this way. Not just one but a plurality of characteristic values are preferably determined.

If a plurality of sub-processes each having a process variable assigned thereto are active in the device and well coupled acoustically to the one or two sensors as the case may be, it is of course basically also possible to determine other characteristic values for other process variables from the second frequency band or other frequency bands in the ultrasonic range. These can be compared with one another, and thereby provide a particularly simple way to infer the operating condition thereof. If the sub-processes are, e.g., different lubricant circuits, the failure of one or more of the circuits, for example, can be detected, or changes (e.g., in respect of flow rate, pressure, or viscosity) in one or more of the circuits can be inferred by comparing the characteristic values.

The first frequency band for condition monitoring is preferably higher than the second frequency band for monitoring the process variable. It has been found that, in the frequency range above 80 kHz (preferably at least in a subrange of the frequency band extending between 90 and 160 kHz), the friction in the bearing as well as mechanical damage in the bearing can be detected directly by measuring material-specific frequencies which are excited in the event of irreversible plastic material deformation. Conversely, the second frequency band is preferably below 80 kHz (preferably at least in a subrange of the frequency band extending between 30 and 80 kHz), as it is there that wideband “noise-shaped” excitations of process variables occur particularly frequently.

By comparing the at least one characteristic value for the process variable with reference values for different operating conditions (often also termed “fingerprints”), an operating condition of a sub-process assigned to the process variable can be inferred.

In accordance with a particularly advantageous embodiment, the at least one characteristic value for the process variable is taken into account for determining the at least one characteristic value for the condition of the bearing. In the simplest case, the at least one characteristic value for the process variable is used to check the plausibility of the at least one characteristic value for the condition of the bearing. By this means, the accuracy of condition monitoring can be improved or rather erroneous results can be detected and eliminated or corrected. In addition, a defective sensor in the first frequency band or a downstream evaluation unit can be detected and the sensor or evaluation unit can be replaced before condition-based maintenance errors occur.

In accordance with another particularly advantageous embodiment, a bearing temperature is additionally measured and at least one characteristic value for the temperature is determined. In this way, the informative value of a sensor for measuring the acoustic emissions can be further improved. A sensor for measuring the temperature can also be accommodated in a sensor device in which the one or two sensors for measuring the acoustic emissions are already accommodated.

The characteristic value for the temperature can be used, for example, for checking the quality of the coupling of the sensor(s) for measuring the acoustic emissions. Thus, in the event of poor sensor coupling, the temperature coupling is typically also poor, i.e., the temperature values are then lower than expected.

The temperature is often an important variable for revealing whether the sub-process assigned to the process variable is operating correctly. The temperature can then be used for checking the plausibility of the at least one characteristic value for the process variable. In the case of an oil circuit, the temperature gives an indication, for example, as to whether the oil is circulating at the desired temperature or rather viscosity. In addition, excessively high temperatures can be detected and therefore the operational reliability further increased without the need for separate instrumentation for measuring the temperature.

The temperature can also be taken into account for determining the at least one characteristic value for the condition of the bearing and used, for example, for checking the plausibility of, or correcting, the at least one characteristic value for the condition of the bearing, thereby improving the accuracy of the condition-based maintenance. It has been found, for example, that in the event of the undesirable condition of mixed friction in the bearing, the temperature in the bearing also increases, but with a time delay after the occurrence of increased acoustic emissions in the ultrasonic range. The time constant for this is dependent on the thermal capacity and geometry of the bearing and moves in the minute range. It is therefore possible, for example, to wait until the associated temperature increase has occurred before inferring mixed friction from increased acoustic emissions detected.

In addition, the temperature measured can also be used to analyze the temperature distribution. In the case of a lubricant circuit, temperature measurement at very low temperatures can be used to detect how far lubricant preheating has progressed in the vicinity of the bearing. The temperature measurement can even be used as a command variable for controlling the preheating.

If a significant temperature gradient is measured, the system is not in thermal equilibrium. For this condition, increased acoustic emissions in the ultrasonic range that arise only temporarily due to different expansions of components are to be expected and are not indicative of permanent damage. Such time segments can be eliminated by additional evaluation of the temperature information for determining the at least one characteristic value for the condition of the bearing.

In accordance with another advantageous embodiment, the at least one characteristic value for the process variable is used to check the plausibility of characteristic values from a condition monitoring system of the sub-process assigned to the process variable. Particularly in the case of a lubricant circuit, comparison with the data of a condition monitoring system for the lubricant circuit is advisable, e.g., comparison with the flow rate determined by the condition monitoring system, the temperature of the lubricant, pump power consumption, or lubricant pressure. This increases the robustness of the information value of the condition monitoring system by providing an additional measurement method (redundancy) and therefore the possibility of plausibility cross-checking.

As already explained above, the process variable is preferably a flow of lubricant through the device, in particular through the bearing.

In accordance with another advantageous embodiment, the industrial device is controlled in an open- and/or closed-loop manner as a function of one or more of the characteristic values. If the characteristic value for the process variable is, for example, a flow of lubricant such as oil, the industrial device is, for example, only started up when the operating temperature is reached, acoustic emissions resulting from a flow of oil and therefore the characteristic value for this process variable having attained a predefined range. If the values of the acoustic emissions resulting from the oil flow are too low or too high, the machine can be placed in another, safe operating condition. It is also possible for the industrial device to be operated at defined, controlled overload in a predefined time window by checking the acoustic emissions in the second frequency band or rather of the therefrom determined at least one characteristic value for the process variable and taking into account the characteristic value for the temperature of the bearing, thereby optimizing the output or yield of the industrial device.

It is also an object of the invention to provide an arrangement for monitoring an industrial device, such as a machine or a system, where the device has a rotating component and a bearing for the component, has a sensor device which is configured to preferably provide simultaneous measurement of acoustic emissions of the device in a first frequency band and a second frequency band in the ultrasonic range, where the first frequency band and the second frequency band are non-overlapping. In addition, the arrangement in accordance with the invention has an evaluation device comprising a first and a second evaluation unit, where the first evaluation unit is configured to determine a characteristic value for the condition of the bearing from a sensor signal of the sensor device in the first frequency band, and where the second evaluation unit is configured to determine a characteristic value for a process variable of a process executing in the device from a sensor signal of the sensor device in the second frequency band.

The first frequency band is advantageously higher than the second frequency band, where preferably the first frequency band is above 80 kHz, in particular extends over at least one subrange of the frequency band between 90 and 160 kHz, and where the second frequency band is preferably below 80 kHz, in particular extends over at least one subrange of the frequency band between 30 and 80 kHz.

In yet another advantageous embodiment of the arrangement in accordance with the invention, reference values for different operating conditions for the at least one characteristic value for the process variable are stored in the second evaluation unit and the second evaluation unit is configured such that it compares the at least one characteristic value determined with the reference values in to infer an operating condition of a sub-process assigned to the process variable.

In accordance with another advantageous embodiment of the arrangement, the evaluation device is configured such that it takes into account the at least one characteristic value for the process variable when determining the at least one characteristic value for the condition of the bearing, in particular it checks the characteristic value for plausibility.

The sensor device preferably has a single sensor both for measuring the acoustic emissions in the first frequency band and for measuring the acoustic emissions in the second frequency band, preferably also a temperature-measuring sensor.

In accordance with a particularly advantageous embodiment of the inventive arrangement, the process variable is the flow of a lubricant through the device, in particular through the bearing.

The arrangement advantageously has an interface for communication with an open and/or closed-loop control device of the industrial device, preferably also an interface for communication with a condition monitoring system for an industrial device sub-process assigned to the process variable. Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and other advantageous embodiments of the invention as claimed in features of the sub-claims will now be explained in greater detail with reference to exemplary embodiments illustrated in the accompanying drawings in which:

FIG. 1 shows an arrangement for monitoring an industrial device comprising a rolling-element bearing and a lubrication system;

FIG. 2 shows an arrangement for monitoring an industrial device comprising a plain bearing and a lubrication system;

FIG. 3 shows an arrangement for monitoring an industrial device comprising a plain bearing and a lubrication system, as well as an adjacent lubrication system;

FIGS. 4-6 show measurement data of an acoustic emission sensor mounted on the gearbox bearing of a rock mill for three different operating cases; and

FIG. 7 is a flowchart of the method in accordance with the invention.

### DETAILED DESCRIPTION OF THE EXEMPLARY EMBODIMENTS

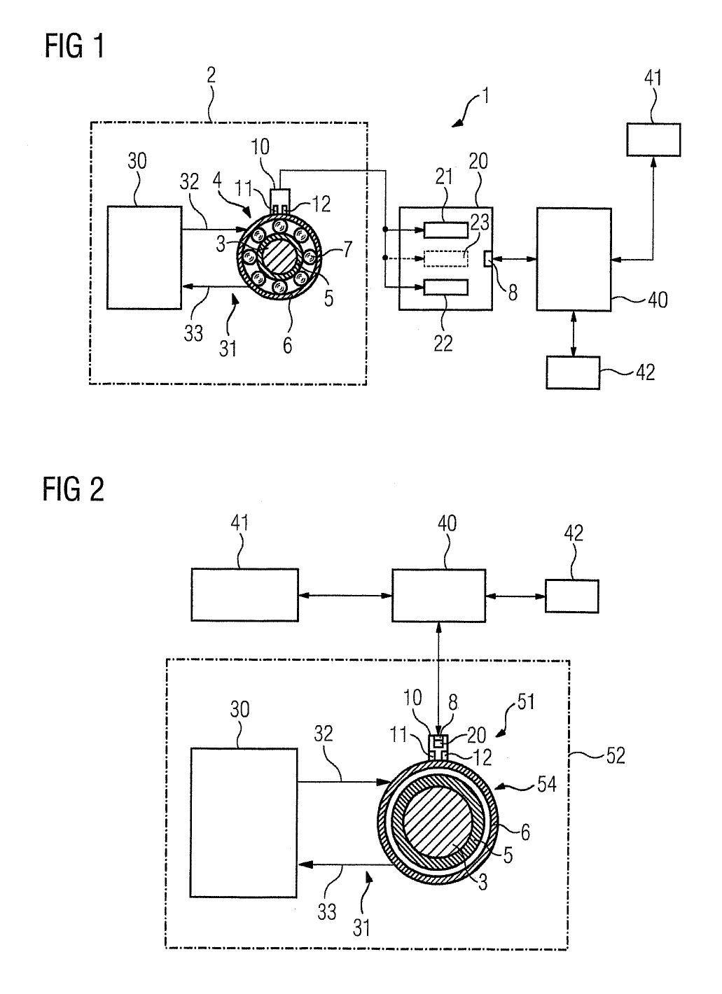

FIG. 1 schematically illustrates an arrangement 1 for monitoring an industrial device 2, such a machine or a system. The device 2 has a rotating component 3, e.g., a gear shaft, and a bearing 4 for the component 3. The bearing 4 is implemented in a per se known manner as a rolling-element bearing having an inner race 5, an outer race 6 and rollers 7 disposed therebetween.

A sensor device 10 is fixed with good acoustic coupling to the bearing 4 and is configured for (preferably simultaneous) measurement of acoustic emissions of the device 1 in a first frequency band and a second frequency band in the ultrasonic range, where the first frequency band and the second frequency band do not overlap. The sensor device 10 has a single structure-borne noise sensor 11 in the form of an “acoustic emission sensor” for measuring both the acoustic emissions in the first frequency band and the acoustic emissions in the second frequency band. The sensor 11 can be implemented as a piezoelectric, piezoresistive, capacitive or inductive sensor. The sensor device 10 also has a sensor 12 for measuring a temperature of the bearing 4.

An evaluation device 20 has a first evaluation unit 21, a second evaluation unit 22 and a third evaluation unit 23. The first evaluation unit 21 is configured to determine a characteristic value for the condition of the bearing 4 from a signal of the sensor 11 in the first frequency band. The second evaluation unit 22 is configured to determine a characteristic value for a process variable of a process running in the device from a signal of the sensor 11 in the second frequency band. The third evaluation unit 23 is configured to determine a characteristic value of the temperature of the bearing 4 from a signal of the temperature sensor 12.

The process variable is the flow of lubricant of a lubrication system 30 through the bearing 4. The lubricant is oil, for example. The lubrication system 30 comprises a lubricant circuit 31 having an inlet line 32 supplying lubricant to the bearing 4 and an outlet line 33 carrying lubricant away from the bearing 4. The lubrication system 30 also comprises other components not shown in greater detail such as a pump, a reservoir, filters, sensors, a heater, or valves.

The sensor 11 is a wideband structure-borne noise sensor that is sensitive both in the frequency range below 80 kHz and in the frequency range above 80 kHz. In the frequency range above 80 kHz, preferably in a first frequency band between 90 and 160 kHz, the friction in the bearing and mechanical damage in the bearing is detected directly by measuring material-specific frequencies that are excited in the event of irreversible plastic material deformation. This sensor 11 is likewise sensitive in the frequency range below 80 kHz. Here, in a second frequency band between 30 and 80 kHz, wideband “noise-shaped” excitation caused by the lubricant circuit 31 occurs. The friction in the lubricant itself and the friction of the lubricant directly against the boundary surfaces produce an ultrasonic excitation which propagates in the industrial device 2, e.g., a housing of a machine. These vibrations are typically also measurable directly on the bearing 4 and therefore detectable by the sensor 11 mounted on the bearing 4. The frequency bands can be separated out from a vibration signal of the sensor 11 in the first evaluation unit 21 and/or second evaluation unit 22 using analog and/or digital filters.

In an alternative embodiment not shown, the sensor device 10 has at least two structure-borne noise sensors that are co-located in a sensor head of the sensor device 10. The resonant frequency of one sensor is between 90 and 160 kHz for monitoring the condition of the bearing 4 and that of another sensor is between 30 and 80 kHz for monitoring the lubricant circuit 31.

For monitoring the lubricant circuit 31 and therefore the lubrication system 30, the envelope as well as RMS and maximum values are formed in the second evaluation unit 22 from the ultrasonic signal in the second frequency band between 30 and 80 kHz. These characteristic values directly characterize the friction in the bearing 4 based on the lubricant flow. If the latter changes, these characteristic values also change.

Reference values (“fingerprints”) for different operating conditions for the lubricant flow are stored in the second evaluation unit 22 and the second evaluation unit 22 is implemented such that it compares the value determined for the lubricant flow with the reference values to infer an operating condition of the lubricant circuit 31 and therefore of the lubrication system 30.

For more detailed analysis, frequency analyses based on the signals of the sensor 11 and the envelope thereof can be carried out, e.g., in order to filter out unwanted signals due to known bearing frequencies or fixed-frequency electrical interference.

The evaluation device 20 can be implemented such that, for determining the characteristic value for the friction of the bearing 4, it takes into account the determined lubricant flow, in particular checks it for plausibility.

The evaluation device 20 has an interface 8 to a network 40 for communication with an open- and/or closed-loop control device 41 of the industrial device 2 and for communication with a separate condition monitoring system 42 of the lubrication system 30. In particular, connection directly to the network 40 (preferably an industrial network based on, e.g., Ethernet, Profinet, Profibus, or OPC-UA) is advantageous, as it enables the characteristic values to be made available in the network 40 for various other systems.

The temperature sensor 12 incorporated in the sensor device 10 increases the information value of the sensor 11. If the sensor 11 is badly coupled to the bearing 4, the temperature coupling is typically also poor, i.e., the temperature values measured by the temperature sensor 12 are then normally lower than expected. The temperature likewise gives an indication as to whether the lubricant circuit 31 is operating at the required temperature or rather viscosity. Excessively high temperatures can therefore be detected. In the case of mixed friction in the bearing 4, the temperature also rises with a delay after the occurrence of increased acoustic emissions. The time constant for this is dependent on the thermal capacity and geometry of the bearing 4. The temperature sensor 12 can also be used to analyze the temperature distribution and can be used at very low temperatures to detect the progress of the preheating process of the lubricant in the vicinity of the bearing 4. The sensor 12 can also be used as a command variable for this control. If a significant temperature gradient is measured, the lubrication system 30 is not in thermal equilibrium. For this condition, increased acoustic emissions are to be expected that arise only temporarily due to different expansions of components and are not indicative of permanent damage. Such time segments can be eliminated by additional evaluation of the temperature information.

Via the interface 8 and the network 40, it is possible for the sensor characteristic values to be used for open- and/or closed loop control of the industrial device 2. For example, the device 2 is not started up until the operating temperature is attained and the acoustic emission characteristic value representing the lubricant flow has reached a required range. If the values of the characteristic value are too high, then the device 2 can be placed in another, safe operating condition. This makes it possible to operate the device 2 with defined, controlled overload in a predefined time window by monitoring the characteristic values of the acoustic emissions and of the temperature, e.g., in order to optimize yield. Altogether, fault conditions of the device 2 can therefore be prevented or terminated.

Via the interface 8 and the network 40, it is possible for the sensor characteristic values to be used to check the plausibility of characteristic values of the condition monitoring system 42 of the lubrication system 30. For example, this makes comparison possible with the flow rate, lubricant temperature, pump power consumption, or lubricant pressure determined by the condition monitoring system 42.

This increases the robustness of the condition monitoring of the lubrication system 30 by providing an additional measuring method (i.e., redundancy) and offers the possibility of plausibility cross-checking.

The evaluation device 20 for creating the characteristic values can (as shown in FIG. 1) be linked directly to the sensor device 10 as a separate electronic assembly, but can also (as shown in FIG. 2) be incorporated in the sensor device 10.

An arrangement 51 for monitoring an industrial device 52 such as a machine or a system, as schematically illustrated in FIG. 2, differs from the arrangement 1 shown in FIG. 1 in that the device 52 has a plain bearing 54 instead of a rolling-element bearing 4 and that the evaluation device 20 is incorporated in the sensor device 10. As the third evaluation unit 23 is therefore directly incorporated in the sensor device 10, the temperature sensor 12 can be, for example, a temperature sensor incorporated in a microcontroller of the third evaluation unit 23.

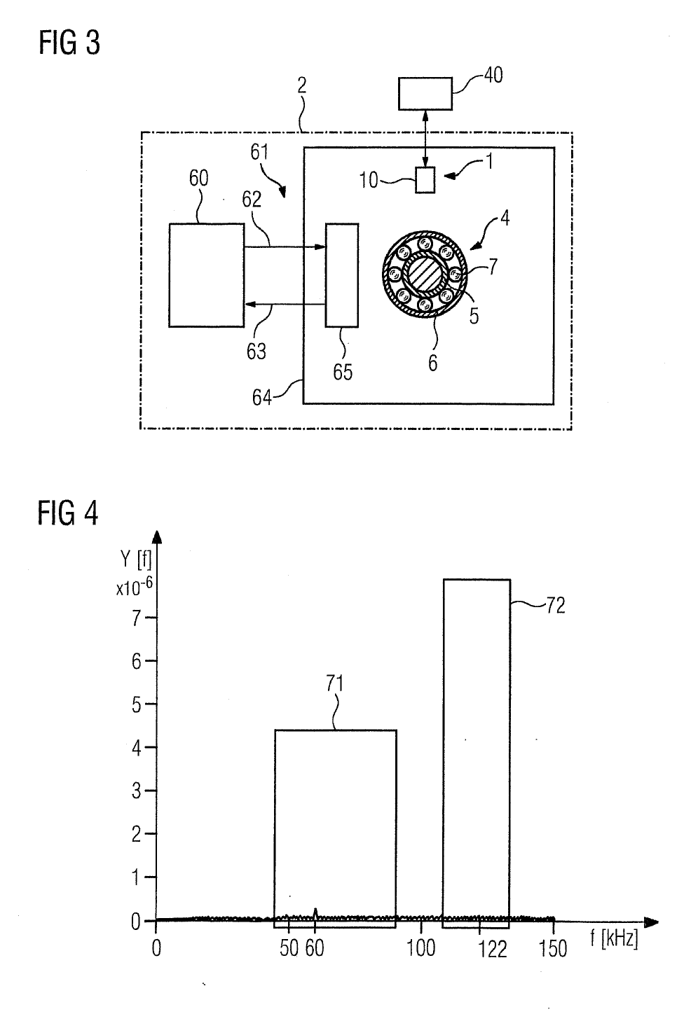

FIG. 3 schematically illustrates monitoring of a lubricant circuit 61 of lubrication system 60 of an adjacent unit 65 by the sensor device 10. Here too the lubricant is oil, for example. Monitoring of the lubricant circuit 61 in addition to the lubricant circuit 31 (see FIG. 1, not shown in FIG. 3) is possible if there is good acoustic coupling to the adjacent lubricant circuit 61, e.g., via a steel or aluminum housing 64 through which the inlet line 32 and the outlet line 33 of the lubricant circuit 31 and an inlet line 62 and an outlet line 63 of the adjacent lubricant circuit 61 are run and to which the sensor device 10 is also fixed. The activity of the two lubricant circuits 31, 61 can then be considered separately and compared. This can be used to detect a failure of one or other of the lubricant circuits 31, 61 or to detect change in the circuit (e.g., change in flow rate, pressure, viscosity).

FIGS. 4-6 show, by way of example, measurement data of an acoustic emission sensor that is mounted on the gearbox bearing of a rock mill and is sensitive in the plotted frequency band 71 around 60 kHz and in the plotted frequency band 72 around 120 kHz, for three different operating cases. The graph shows the amplitude Y versus the frequency f.

FIG. 4 shows a first operating case in which the shaft is not rotating (i.e., has a speed of 0 rpm). A first lubricant circuit in the form of a high-pressure oil circuit is deactivated, a second lubricant circuit in the form of a low-pressure oil circuit is likewise deactivated. As may be seen from FIG. 4, no appreciable acoustic emissions are detectable in either of the two frequency bands 71, 72.

FIG. 5 shows a second operating case in which the shaft is not rotating (i.e. has a speed of 0 rpm). Both the first lubricant circuit in the form of a high-pressure oil circuit and the second lubricant circuit in the form of a low-pressure oil circuit are activated. As may be seen from FIG. 5, significant acoustic emissions are detectable in the lower frequency band 72 around 60 kHz.

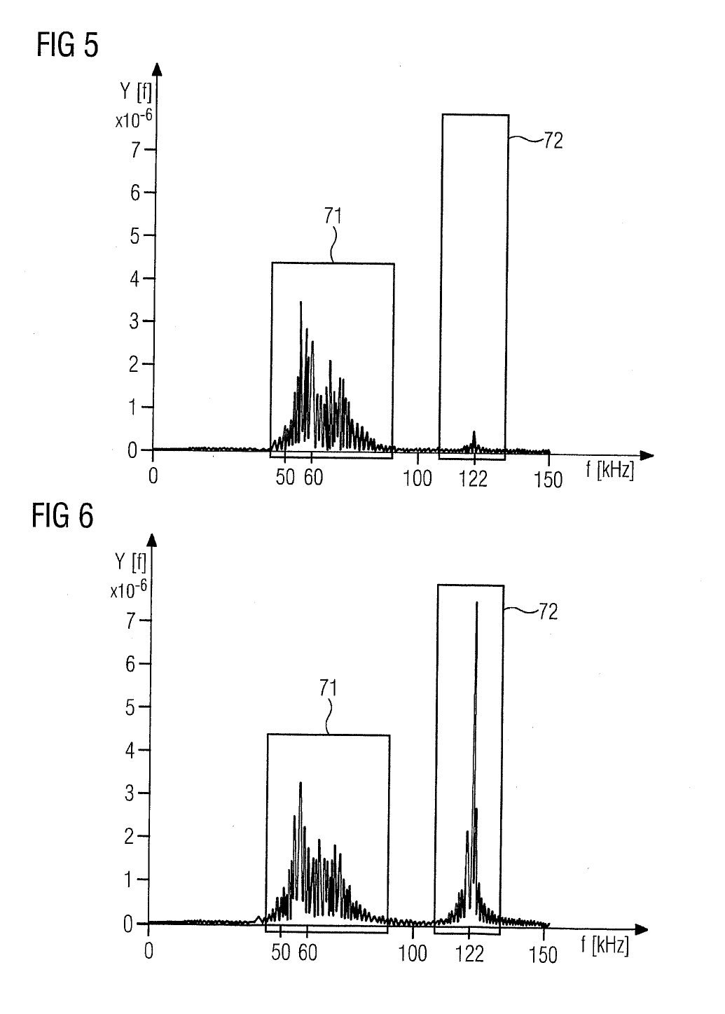

FIG. 6 shows a third case in which the shaft is now rotating at a constant speed of 1000 rpm. Both the first lubricant circuit in the form of a high-pressure oil circuit and the second lubricant circuit in the form of a low-pressure oil circuit are activated. As may be seen from FIG. 6, significant acoustic emissions are now likewise detectable in the higher frequency band 71 around 120 kHz.

This clearly illustrates that the oil circuit(s) and the bearing friction produce signals in different frequency ranges which can be evaluated and monitored separately.

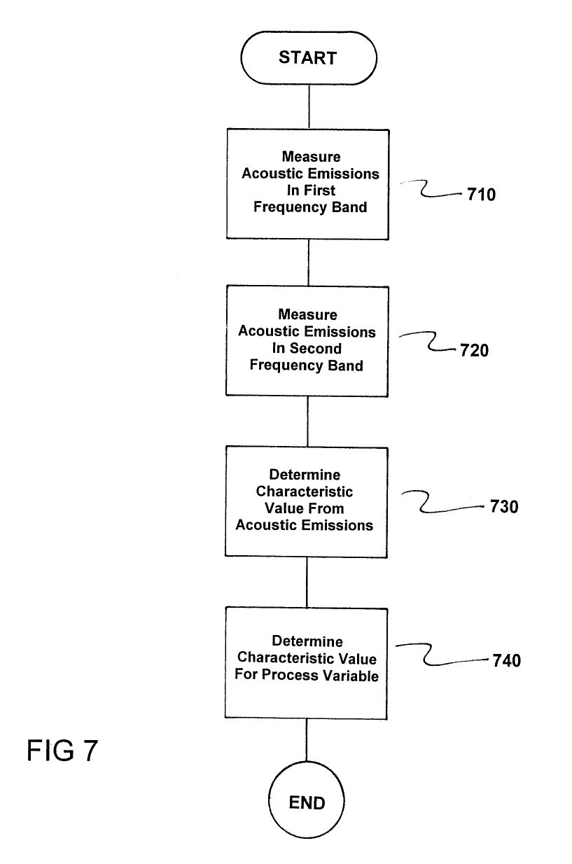

FIG. 7 is a flowchart of a method for monitoring an industrial device (2) having a rotating component (3) and a bearing (4) for the rotating component. During operation of the device (2), the method comprises measuring acoustic emissions of the industrial device (2) in a first frequency band (71) in an ultrasonic range, as indicated in step 710.

Next, acoustic emissions of the industrial device (2) in a second frequency band (72) in the ultrasonic range are measured, as indicated in step 720. In accordance with invention, the first frequency band (71) and the second frequency band (72) are non-overlapping.

Next, at least one characteristic value for the condition of the bearing (4) is determined from acoustic emissions of the industrial device (1) in the first frequency band (71), as indicated in step 730.

At least one characteristic value for a process variable of a process running in the device (2) is now determined from the acoustic emissions of the industrial device (2) in the second frequency band (72) to monitor the process variable, as indicated in step 740.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A method for monitoring an industrial device having a rotating component and a bearing for the rotating component, the method comprising during operation of the device:
measuring acoustic emissions of the industrial device in a first frequency band in an ultrasonic range;
measuring acoustic emissions of the industrial device in a second frequency band in the ultrasonic range, the first frequency band and the second frequency band being non-overlapping;
determining at least one characteristic value for the condition of the bearing from acoustic emissions of the industrial device in the first frequency band; and
determining at least one characteristic value for a process variable of a process running in the device from the acoustic emissions of the industrial device in the second frequency band to monitor the process variable.

18. The method as claimed in claim 17, wherein the first frequency band is higher than the second frequency band.

19. The method as claimed in claim 18, wherein the first frequency band is above 80 kHz and the second frequency band is below 80 kHz.

20. The method as claimed in claim 19, wherein the first frequency band extends over at least one subrange of a frequency band between 90 and 160 kHz, and the second frequency band extends over at least one subrange of a frequency band between 30 and 80 kHz.

21. The method as claimed in claim 17, further comprising:
comparing the at least one characteristic value for the process variable with reference values for different operating conditions to infer an operating condition of a sub-process assigned to the process variable.

22. The method as claimed in claim 17, wherein the at least one characteristic value for the process variable is taken into account to determine the at least one characteristic value for the condition of the bearing.

23. The method of claim 22, wherein the characteristic value for the condition of the bearing is checked for plausibility.

24. The method as claimed in claim 17, further comprising:
measuring a temperature of the bearing; and
determining at least one characteristic value for the measured temperature.

25. The method as claimed in claim 17, wherein the at least one characteristic value for the process variable is used to check the plausibility of characteristic values from a condition monitoring system of the sub-process assigned to the process variable.

26. The method as claimed in claim 17, wherein the process variable is a flow of a lubricant through the industrial device.

27. The method as claimed in claim 26, wherein the flow of the lubricant is through the bearing of the industrial device.

28. The method as claimed in claim 17, wherein a single sensor is utilized to measure the acoustic emissions in the first frequency band and to measure the acoustic emissions in the second frequency band.

29. The method as claimed in claim 17, wherein the device is controlled in at least one of (i) an open-loop and (ii) closed-loop manner as a function of at least one of the characteristic values.

30. The method as claimed in claim 17, wherein the industrial device comprises one of (i) a machine and an industrial system.

31. An arrangement for monitoring an industrial device having a rotating component and a bearing for said rotating component, comprising:
a sensor configured to measure acoustic emissions of the industrial device in a first frequency band and a second frequency band in the ultrasonic range, the first frequency band and the second frequency band being non-overlapping;
an evaluator having a first evaluation unit and a second evaluation unit;
wherein the first evaluation unit is configured to determine a characteristic value for the condition of the bearing from a sensor signal of the sensor in the first frequency band; and
wherein the second evaluation unit is configured to determine a characteristic value for a process variable of a process executing in the device from a sensor signal of the sensor device in the second frequency band to monitor the process variable.

32. The arrangement as claimed in claim 31, wherein the first frequency band is higher than the second frequency band.

33. The arrangement as claimed in claim 32, wherein the first frequency band is above 80 kHz and the second frequency band is below 80 kHz.

34. The arrangement as claimed in claim 33, wherein the first frequency band extends over at least one subrange of a frequency band between 90 and 160 kHz, and the second frequency band extends over at least one subrange of a frequency band between 30 and 80 kHz.

35. The arrangement as claimed in claim 31, wherein reference values for different operating conditions for the at least one characteristic value for the process variable are stored in the second evaluation unit; and
wherein the second evaluation unit is configured to compare the at least one characteristic value determined with said reference values to infer an operating condition of a sub-process assigned to the process variable.

36. The arrangement as claimed in claim 31, wherein the evaluator is configured to take into account the at least one characteristic value for the process variable to determine the at least one characteristic value for the condition of the bearing.

37. The arrangement of claim 36, wherein the evaluator checks the characteristic value for plausibility.

38. The arrangement as claimed in claim 31, wherein the sensor includes a first sensor to measure the acoustic emissions in the first frequency band and to measure the acoustic emissions in the second frequency band.

39. The arrangement as claimed in claim 38, wherein the sensor includes a second sensor to measure a temperature of the bearing.

40. The arrangement as claimed in claim 31, wherein the process variable is the flow of a lubricant through the device.

41. The arrangement as claimed in claim 40, wherein the flow of the lubricant is through the bearing of the industrial device.

42. The arrangement as claimed in claim 31, wherein the evaluation device includes an interface for communicating with at least one of (i) an open-loop controller and (ii) a closed-loop controller of the industrial device for communicating with a condition monitoring system for a sub-process of the industrial device, said sub-process being assigned to the process variable.

43. The arrangement as claimed in claim 31, wherein the industrial device comprises one of (i) a machine and an industrial system.
